(19) United States
(12) Patent Application Publication
(10) Pub. No.: US 2005/0099341 A1
(43) Pub. Date: May 12, 2005

(54) Antenna for a wireless hearing aid system

(75) Inventors: Wen Hui Zhang, Burlington (CA); Frederick E. Sykes, Burlington (CA)

Correspondence Address: David B. Cochran, Esq.;Jones Day, North Point, 901 Lakeside Avenue, Cleveland, OH, 44114, US

(73) Assignee: Gennum Corporation

(21) Appl. No.: 10/986,394

(22) Filed: Nov. 11, 2004

Related U.S. Application Data
(60) Provisional application No. 60/519,215, filed on Nov. 12, 2003.

(51) Int. Cl. H01Q 1/38

(52) U.S. Cl. 343/700 MS; 343/866; 343/718

(57) ABSTRACT

A wireless communication system having a loop antenna is provided. The wireless communication system may be a wireless hearing aid having a housing structure and a communication system for receiving wireless signals. The loop antenna may be affixed to a flexible dielectric substrate, along with at least a portion of a matching network for coupling the loop antenna to the communication system.

### CROSS-REFERENCE TO RELATED APPLICATION

This application claims priority from and is related to the following prior application: “Electrically Small Loop Antenna On Flex For Ultra-Low Power Wireless Hearing Aid System,” U.S. Provisional Application No. 60/519,215, filed Nov. 12, 2003. This prior application, including the entirety of the written description and drawing figures, is hereby incorporated into the present application by reference.

### FIELD

The technology described in this patent document relates generally to the field of antennas. More particularly, the patent document describes a loop antenna on flex material that is particularly well-suited for use in an ultra-low power wireless hearing aid system, but which may also have general applications in the field of wireless communication devices.

### BACKGROUND

Antennas at radio or microwave frequency are typically not robust when dealing with certain application issues, such as human proximity, or against the small size requirement that is necessary for hearing aids, such as BTE (behind the ear), ITC (in the canal), and CIC (completely in the canal) shell sizes. Loop antennas in various communication systems are typically built on substrates and the matching circuits are typically fixed on the substrates as well.

### BRIEF DESCRIPTION OF THE DRAWINGS

FIG. 1 is a layout of an example loop antenna;

FIG. 2 illustrates an example loop antenna on flex attached to a behind the ear hearing aid device;

FIG. 3 is an example matching topology for a miniature wireless device;

FIG. 4 is an example matching topology for a miniature wireless device where a portion of the matching network is located within the shell of the device;

FIG. 5 is a schematic diagram of an example narrow bandwidth matching circuit;

FIG. 6 is a schematic diagram of an example medium bandwidth matching circuit;

FIG. 7 is a perspective view of an example loop antenna on flex attached to a behind the ear hearing aid device;

FIG. 8 is a side view of an example loop antenna on flex attached to a behind the ear hearing aid device;

FIG. 9 is a line drawing of another example loop antenna; and

FIG. 10 is a layout of the example loop antenna of FIG. 9.

### DETAILED DESCRIPTION

An electrically small loop antenna, as described herein, may enable hearing aids or other communication devices to have short-range wireless transceiver functions, such as reception of digital/analog audio, binaural processing, as well as wireless programming and/or configuration. The antenna described herein is preferably a 900 MHz antenna, although other frequencies are possible. A 900 MHz antenna may enable high sensitivity in a very small space and thus is well suited for installation in the irregular shape of a hearing aid shell, for example.

The electrically small loop antenna may be built on a flexible layer of substrate, commonly known as flex, that can be attached to non-conductive surfaces. The disclosed matching circuit may also be on the flex. In this manner, the electrically small loop antenna may be put on an external surface of the shell of a BTE hearing aid or within the hearing aid shell.

Furthermore, the electrically small loop antenna may be incorporated in any miniature wireless system requiring the reception and transmission of audio or bi-directional data transfer at extremely low power consumption. This includes, but is not limited to, hearing aids, assistive listening devices, wireless headsets, ear-buds, body worn control, sensor, and communication devices. An example of a wireless hearing aid system that may include the electrically small loop antenna described herein is described in the commonly owned U.S. patent application Ser. No., ______, entitled “Hearing Instrument Having A Wireless Base Unit,” and which is incorporated herein by reference.

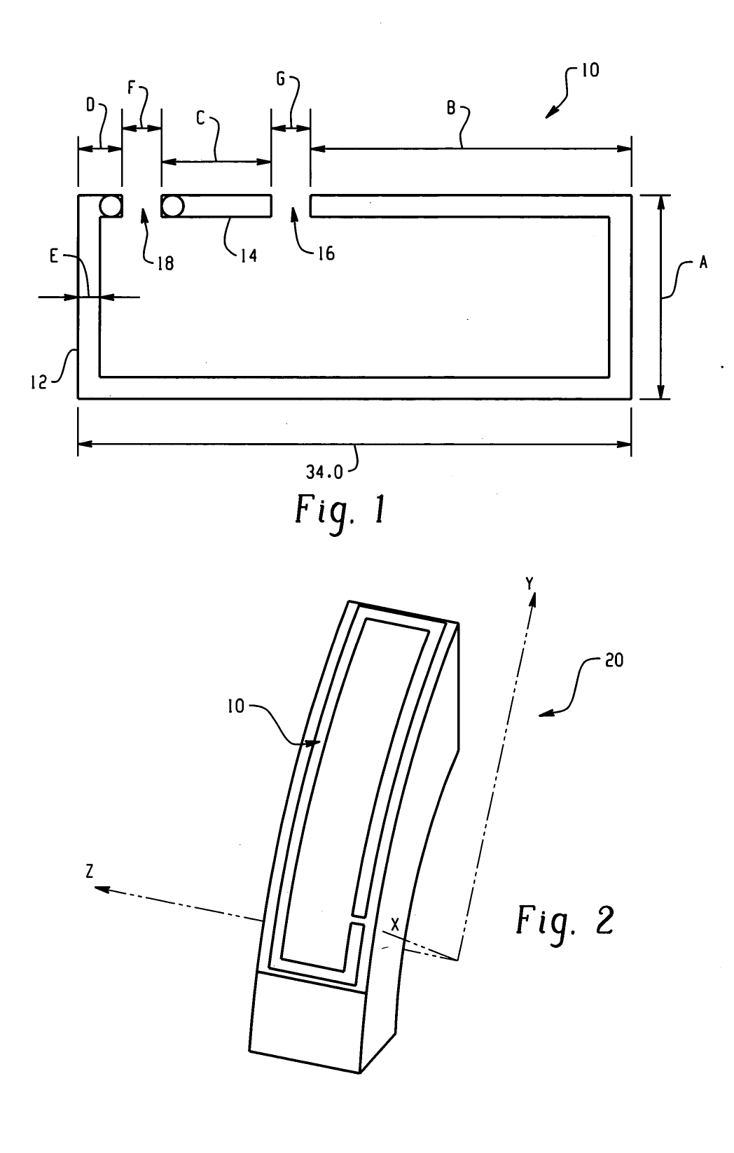

FIG. 1 shows a layout diagram of an example electrically small loop antenna 10. The loop antenna 10 has a first portion 12 and a second portion 14. The first and second antenna portions 10, 12 define two gaps 16, 18. Also illustrated are example dimensions for the antenna portions 12, 14 and the two gaps 16, 18, which are labeled A-G.

Several prototypes of the example loop antenna 10 were constructed, each with different dimensions A-G. The prototype loop antennas were analyzed, including an analysis of the human proximity to the antenna. The measurement results show that the antenna loss over working frequency range was less than 5 dB, the antenna demonstrated a reduced human detuning effect, and the antenna was omni-directional. Table 1 illustrates the dimensions of the prototype antennas and the resulting capacitances.

TABLE 1

| Build | A | B | C | D | E | F | G | C_a(pF) | C_b(pF) |
|---|---|---|---|---|---|---|---|---|---|
| 1 | 8.5 | 24.0 | 3.75 | 4.0 | 0.8 | 2.0 | 0.25 | 0.5 | 0.7 |
| 2 | 8.5 | 24.0 | 3.75 | 4.0 | 1.0 | 2.0 | 0.25 | 0.5 | 0.7 |
| 3 | 8.5 | 24.0 | 3.75 | 4.0 | 1.2 | 2.0 | 0.25 | 0.35 | 0.7 |
| 4 | 8.5 | 12.0 | 3.75 | 16.0 | 1.2 | 2.0 | 0.25 | 0.5 | 0.7 |
| 5 | 14.5 | 24.0 | 3.75 | 4.0 | 1.2 | 2.0 | 0.25 | 0.5 | 0.55 |
| 6 | 14.5 | 12.0 | 3.75 | 16.0 | 1.2 | 2.0 | 0.25 | 0.6 | 0.70 |
| | All | | | | | | | | |
| | sizes | | | | | | | | |
| | in mm | | | | | | | | |

The electrically small loop antenna 10 of FIG. 1 may be attached to non-conductive surfaces, such as Polyethylene, FR-4, Duroid, or others. The loop antenna 10 may, for example, be attached to a thin layer of flex that is attached to the shell of a BTE hearing aid. FIGS. 2, 7, and 8 illustrate examples of electrically small loop antennas on flex attached to the shell of a BTE hearing aid.

The loop antenna's efficiency is related to the area covered by the antenna aperture, as well as the size of the aperture, as shown by Table 1. Therefore, the area of the loop antenna affects the performance of the system, including parameters such as receiver sensitivity and transmission range. Attaching the antenna to the shell of the BTE as shown in FIGS. 2, 7, and 8 utilizes the limited size of the antenna to achieve high sensitivity, low loss and optimal performance for a wireless system. The antenna may be attached to the inner surface of the shell, or it may be attached to the outer surface of the shell to maximize the size of the aperture.

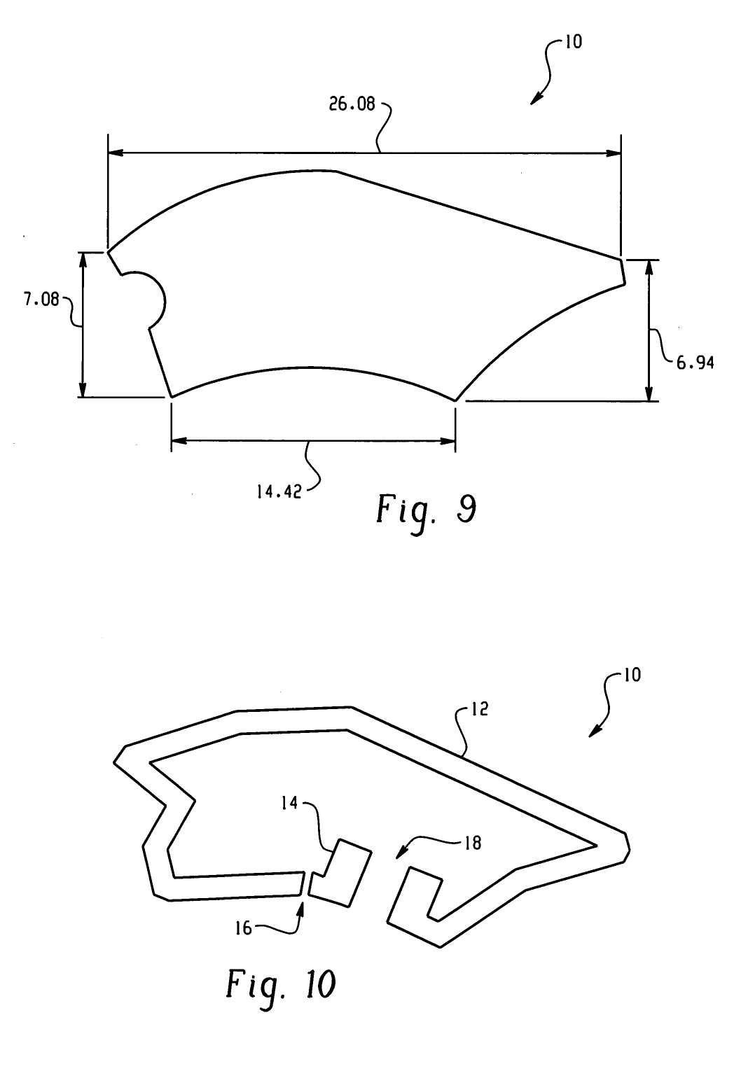

FIGS. 9 and 10 depict an irregular shape that corresponds to the shape of the shell of an example BTE hearing aid. By matching the shape of the loop antenna to the irregular shape of the BTE hearing aid, the aperture of the antenna may be maximized to the space available on the shell of the hearing aid. FIG. 9 shows the shape of an example BTE hearing aid, including example dimensions. FIG. 10 shows an example loop antenna having a shape corresponding to the BTE hearing aid shape of FIG. 9. The size of the antenna may be +100%, −25% extended.

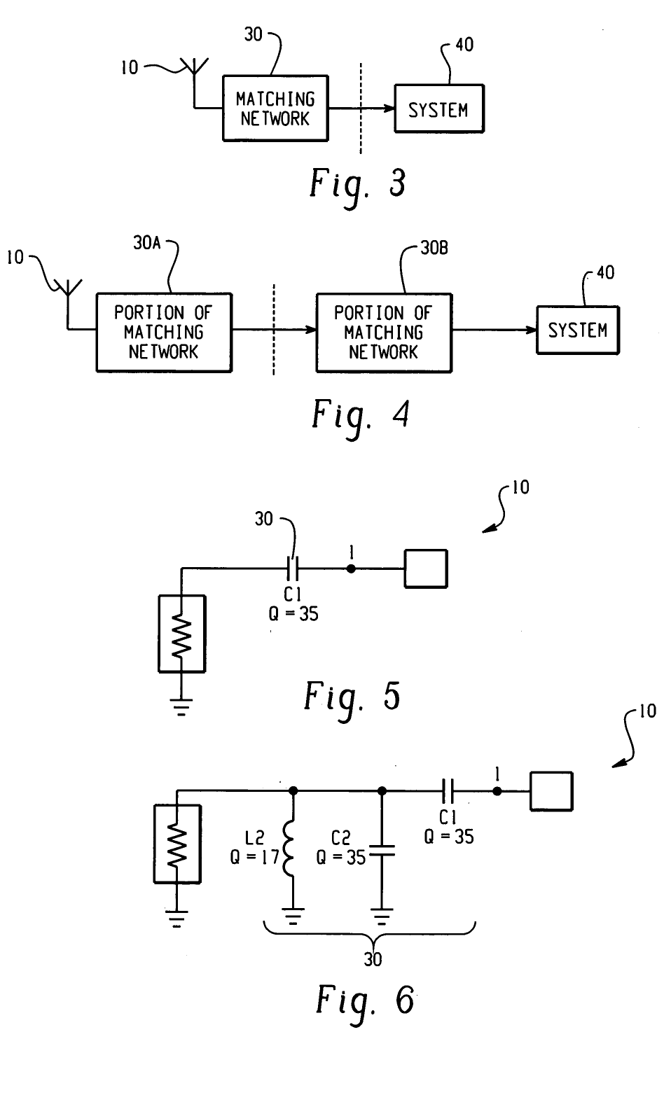

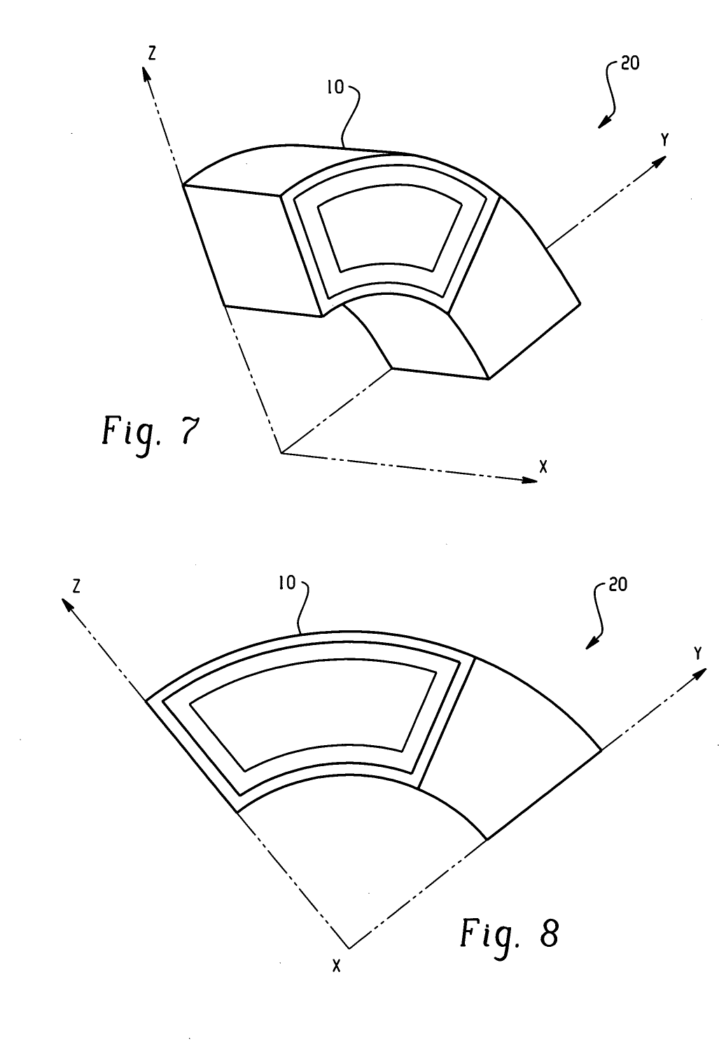

FIGS. 3 and 4 illustrate two example hearing instrument topologies in which one or more matching networks 30, 30A, 30B are coupled between the loop antenna 10 and a hearing aid system 40. Also illustrated in FIGS. 3 and 4 is a dotted line that represents the hearing aid shell. The matching network(s) 30, 30A, 30B function as an interface between the loop antenna 10 and the communication circuitry 40 in the hearing aid, and may increase the efficiency of the antenna 10. The loop antenna 10 may be coupled to the matching network(s) 30, 30A at both antenna feeding points, or alternatively one antenna feeding point may be coupled to a matching network 30, 30A and the other feeding point to ground. In the example of FIG. 3, the matching network 30 is attached to the outer surface of the hearing aid shell, typically on the flex material that carries the antenna as illustrated by the placement of the dotted line. In the example of FIG. 4, a first portion 30A of the matching network is attached to the outer surface of the hearing aid shall and a second portion 30B of the matching network is contained within the hearing aid shell. For example, FIG. 6 shows a matching network 30 comprising capacitors C1, C2 and inductor L2. Of these three passive elements C1 may be placed on the flex material, such as in the gap 16 shown in FIG. 7, whereas elements C2 and L2 may be placed on a circuit board within the hearing aid housing.

There are at least two different matching networks for a 50 ohm system. One is for narrow band conjugate matching, and the other is for medium bandwidth matching. Considering the limitation of the size and space for BTE hearing aid application, the narrow band conjugate method may be preferable.

FIG. 5 shows an example of a narrow band matching network. The matching network includes a capacitor 30 (C1) that is coupled in series between the loop antenna 10 and the hearing aid communications circuitry. The capacitor 30 (C1) on flex (such as in the gap 16 shown in FIG. 1) has a strong tuning effect on the center working frequency. The combination of the radiation resistance, the Q factor of the capacitor 30 (C1) (35 in this example), and the loss from the substrate and conductor determines the antenna bandwidth (e.g., 3 dB) Measurements of the prototype antennas described above demonstrated a center frequency that is adjustable around 900 MHz. The example 3 dB bandwidth is about 16.95%.

FIG. 6 shows an example of a medium band matching network. The matching network includes a first capacitor C1 coupled in series between the loop antenna and the hearing aid communications circuitry, and an LC circuit (C2, L2) coupled in parallel with the loop antenna. The LC circuit includes a second capacitor C2 and an inductor L2. In this example, both capacitors C1, C2 have a Q value of 35, and the inductor has a Q value of 17. Although the example medium band matching circuit shown in FIG. 6 can cover 25% 3 dB bandwidth, it may not be preferred for hearing aids due to size and space limitations.

1. A wireless hearing aid having a communication system positioned within a housing structure for receiving and processing wireless signals and for presenting those signals to a wearer of the hearing aid, the housing structure being positioned in close proximity to the human body of the wearer, the wireless hearing aid comprising:
a loop antenna configured on a flexible dielectric substrate; and
a matching network coupling the loop antenna to the communication system, wherein at least a portion of the matching network is affixed to the flexible dielectric substrate;
wherein the flexible dielectric is affixed to the housing structure of the wireless hearing aid.

2. The wireless hearing aid of claim 1, wherein the housing structure includes an inner surface and an outer surface.

3. The wireless hearing aid of claim 2, wherein the flexible dielectric substrate is affixed to the inner surface of the housing structure.

4. The wireless hearing aid of claim 2, wherein the flexible dielectric substrate is affixed to the outer surface of the housing structure.

5. The wireless hearing aid of claim 1, wherein the wireless hearing aid is a behind the ear (BTE) hearing aid, and the housing structure is positioned behind the ear of the wearer.

6. The wireless hearing aid system of claim 1, wherein the wireless hearing aid is a completely in the canal (CIC) hearing aid, an in the canal (ITC) hearing aid, or in the ear (ITE) hearing aid.

7. The wireless hearing aid system of claim 1, wherein the loop antenna is configured to operate at approximately 900 MHz.

8. The wireless hearing aid system of claim 1, wherein the loop antenna is positioned along a periphery of a portion of the housing structure so as to maximize the aperture of the loop antenna.

9. The wireless hearing aid system of claim 1, wherein the received wireless signals are used, in part, to configure the operation of the wireless hearing aid.

10. The wireless hearing aid system of claim 1, wherein the communication system includes a receiver and a transmitter, the loop antenna being utilized for both receiving wireless signals and transmitting wireless signals.

11. The wireless hearing aid system of claim 1, wherein the loop antenna includes two portions separated by a pair of gaps, wherein the portion of the matching network that is affixed to the flexible dielectric substrate is positioned within one of the pair of gaps.

12. The wireless hearing aid system of claim 1, wherein the flexible dielectric substrate is made from polyethylene, FR-4, or Duroid.

13. The wireless hearing aid system of claim 1, wherein the matching network is a narrow band matching network comprising a capacitor.

14. The wireless hearing aid system of claim 13, wherein the capacitor is affixed to the flexible dielectric substrate.

15. The wireless hearing aid system of claim 14, wherein the loop antenna includes a gap to which the capacitor is connected.

16. The wireless hearing aid system of claim 1, wherein the matching network is a medium band matching network comprising a pair of capacitors and an inductor.

17. The wireless hearing aid system of claim 16, wherein one of the pair of capacitors is connected in series with the loop antenna and the communications system and the other capacitor and the inductor are connected between the loop antenna and ground.

18. The wireless hearing aid system of claim 17, wherein the capacitor connected in series with the antenna is affixed to the flexible dielectric substrate and the other capacitor and the inductor are positioned within the housing structure.
